(19) United States
(12) Patent Application Publication
(10) Pub. No.: US 2022/0271332 A1
(43) Pub. Date: Aug. 25, 2022

(54) STACKED SOLID-STATE BATTERY

(71) Applicant: SEIKO EPSON CORPORATION, Tokyo (JP)

(72) Inventors: Tomofumi YOKOYAMA, Matsumoto-shi (JP); Kei KAMAKURA, Suwa-gun Hara-mura (JP); Hitoshi YAMAMOTO, Chino-shi (JP)

(21) Appl. No.: 17/652,640

(22) Filed: Feb. 25, 2022

(30) Foreign Application Priority Data
Feb. 25, 2021 (JP) 2021-028272

(51) Int. Cl. H01M 10/0562; H01M 10/14; H01M 50/569

(52) U.S. Cl. CPC H01M 10/0562; H01M 10/14; H01M 50/569; H01M 10/0436

(57) ABSTRACT

A stacked solid-state battery according to the present disclosure has a configuration in which a plurality of cells, each including a positive electrode layer, a negative electrode layer, and a solid electrolyte layer provided between the positive electrode layer and the negative electrode layer, are stacked such that the positive electrode layers or the negative electrode layers of adjacent cells are disposed to face each other and, contains a first solid electrolyte represented by the following composition formula (1).

(Li₇₋₃ₓGaₓ)(La_{3-y}Nd_{y})Zr₂O₁₂ (1)

(In the formula (1), 0.1≤x≤1.0 and 0.01≤y≤0.20.)

The present application is based on, and claims priority from JP Application Serial Number 2021-028272, filed Feb. 25, 2021, the disclosure of which is hereby incorporated by reference herein in its entirety.

### BACKGROUND

### 1. Technical Field

The present disclosure relates to a stacked solid-state battery.

### 2. Related Art

Lithium batteries have been used as power sources for a plurality of electric devices including portable information devices. In particular, all-solid-state batteries using a solid electrolyte for conduction of lithium between positive and negative electrodes have been proposed as the lithium batteries achieving both high energy density and safety.

The solid electrolyte attracts attention as a highly safe material since conduction of lithium ions is possible in the solid electrolyte without using an organic electrolytic solution and leakage of the electrolytic solution, volatilization of the electrolytic solution due to drive heat generation, or the like does not occur.

In order to achieve both a battery capacity per unit volume and charge/discharge rate characteristics, a so-called stacked battery in which a plurality of cells are stacked and integrated is proposed for the all-solid-state battery using such a solid electrolyte (see, for example, WO2012/020699).

However, since an interface between an electrode and the solid electrolyte is likely to be in a point contact and a large electrical resistance is generated, there is a problem that a loss of the battery capacity becomes large due to an overvoltage or an ohmic drop when a charge/discharge rate is increased.

### SUMMARY

The present disclosure is made to solve the above problems, and can be implemented as the following application examples.

A stacked solid-state battery according to an application example of the present disclosure has a configuration in which a plurality of cells, each including a positive electrode layer, a negative electrode layer, and a solid electrolyte layer provided between the positive electrode layer and the negative electrode layer, are stacked such that the positive electrode layers or the negative electrode layers of adjacent cells are disposed to face each other, and the stacked solid-state battery contains:

a first solid electrolyte represented by the following composition formula (1):

(Li₇₋₃ₓGaₓ)(La_{3-y}Nd_{y})Zr₂O₁₂ (1)

(in the formula (1), 0.1≤x≤1.0 and 0.01≤y≤0.20).

In the stacked solid-state battery according to another application example of the present disclosure, the first solid electrolyte is contained in the solid electrolyte layer.

In the stacked solid-state battery according to another application example of the present disclosure, the solid electrolyte layer contains a second solid electrolyte having a NASICON-type crystal structure in addition to the first solid electrolyte.

In the stacked solid-state battery according to another application example of the present disclosure, the second solid electrolyte is a lithium-containing phosphate compound.

In the stacked solid-state battery according to another application example of the present disclosure, 0.10≤X1/X2≤9.0 is satisfied where a content of the first solid electrolyte is X1 [mass %] and a content of the second solid electrolyte is X2 [mass %] in the solid electrolyte layer.

The stacked solid-state battery according to another application example of the present disclosure further includes: an internal current collecting layer between the adjacent cells.

### BRIEF DESCRIPTION OF THE DRAWINGS

FIG. 1 is a cross-sectional view schematically showing a cross-sectional structure of a stacked solid-state battery according to a first embodiment.

FIG. 2 is a cross-sectional view schematically showing a cross-sectional structure of a stacked solid-state battery according to a second embodiment.

FIG. 3 is a cross-sectional view schematically showing a cross-sectional structure of a stacked solid-state battery according to a third embodiment.

FIG. 4 is a cross-sectional view schematically showing a cross-sectional structure of a stacked solid-state battery according to a fourth embodiment.

FIG. 5 is a cross-sectional view schematically showing a cross-sectional structure of a stacked solid-state battery according to a fifth embodiment.

FIG. 6 is a cross-sectional view schematically showing a cross-sectional structure of a stacked solid-state battery according to a sixth embodiment.

### DESCRIPTION OF EXEMPLARY EMBODIMENTS

Hereinafter, preferred embodiments according to the present disclosure will be described in detail.

### 1 First Embodiment

First, a stacked solid-state battery according to a first embodiment will be described.

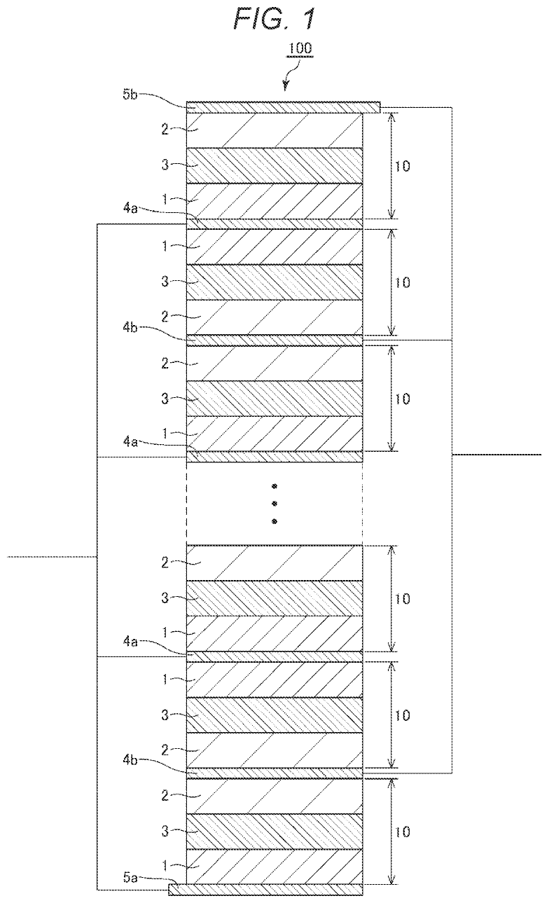

FIG. 1 is a cross-sectional view schematically showing a cross-sectional structure of the stacked solid-state battery according to the first embodiment.

The stacked solid-state battery according to the present disclosure has a configuration in which a plurality of cells, each including a positive electrode layer, a negative electrode layer, and a solid electrolyte layer provided between the positive electrode layer and the negative electrode layer, are stacked such that the positive electrode layers or the negative electrode layers of adjacent cells are disposed to face each other. The stacked solid-state battery according to the present disclosure contains a first solid electrolyte represented by the following composition formula (1).

(Li₇₋₃ₓGaₓ)(La_{3-y}Nd_{y})Zr₂O₁₂ (1)

(In the formula (1), 0.1≤x≤1.0 and 0.01≤y≤0.20.)

Accordingly, it is possible to provide a stacked solid-state battery in which an interface between the first solid electrolyte and other composite oxides such as an active material is likely to be fused and an internal resistance is lower than that in the related art, and which is suitable for a charge/discharge operation at a high rate.

A reason why such an excellent effect is obtained is considered to be that, in the first solid electrolyte, diffusivity in a crystal is increased and an ion conduction resistance is reduced by substituting a Li site of a garnet-type solid electrolyte with trivalent Ga at a predetermined ratio, and grain growth of a solid electrolyte crystal is prevented by substituting a La site with Nd at a predetermined ratio, so that a contact area at an interface between the solid electrolyte and other battery materials is increased and an output is improved.

In contrast, when the above conditions are not satisfied, the above excellent effect cannot be obtained.

For example, when a solid oxide having a composition containing Li, Ga, La, and Zr and not containing Nd is used instead of the first solid electrolyte, there is a problem that a close interface cannot be obtained and an internal resistance of the battery increases since the grain growth of the solid electrolyte predominates and coarse grains are formed.

In addition, when a solid oxide having a composition containing Li, La, Nd, and Zr and not containing Ga is used instead of the first solid electrolyte, there is a problem that diffusivity of lithium ions inside the solid electrolyte decreases, adhesiveness at the interface decreases, and the internal resistance increases.

In the composition formula (1), when a value of x is less than the lower limit value, element diffusion on a surface of the solid electrolyte is likely to occur during sintering, characteristics are impaired, and a good interface is less likely to be obtained.

In addition, in the composition formula (1), when the value of x is larger than the upper limit value, there is a problem that a high resistance layer having a different phase is likely to be formed at the interface, and the internal resistance is rather increased.

In the composition formula (1), when a value of y is less than the lower limit value, element diffusion on a surface of the solid electrolyte is likely to occur during sintering, characteristics are impaired, and a good interface is less likely to be obtained.

In addition, in the composition formula (1), when the value of y is larger than the upper limit value, there is a problem that ion conductivity decreases and the internal resistance of the battery increases due to inhibition of the diffusion of lithium ions inside the crystal.

In particular, a stacked solid-state battery 100 according to the present embodiment includes a plurality of cells each including a positive electrode layer 1, a negative electrode layer 2, and a solid electrolyte layer 3 provided between the positive electrode layer 1 and the negative electrode layer 2. The stacked solid-state battery 100 has a structure in which the plurality of cells 10 are stacked such that electrodes of the same polarity, that is, the positive electrode layers 1 or the negative electrode layers 2 in adjacent cells 10 are disposed to face each other. The adjacent cells 10 are bonded to each other via an internal current collecting layer 4a or an internal current collecting layer 4b. The stacked solid-state battery 100 contains the first solid electrolyte represented by the above composition formula (1).

The first solid electrolyte may be contained in any part of the stacked solid-state battery 100, and for example, may be contained in at least one of the positive electrode layer 1, the negative electrode layer 2, the solid electrolyte layer 3, the internal current collecting layer 4a, and the internal current collecting layer 4b.

### 1-1 First Solid Electrolyte

Hereinafter, the first solid electrolyte contained in the stacked solid-state battery according to the present disclosure will be described in detail.

As described above, the first solid-state battery is represented by the composition formula (1).

The value of x in the composition formula (1) may be 0.1 or more and 1.0 or less, preferably 0.2 or more and 0.9 or less, more preferably 0.3 or more and 0.8 or less, and still more preferably 0.4 or more and 0.7 or less.

Accordingly, the above effects are more remarkably exhibited.

The value of y in the composition formula (1) may be 0.01 or more and 0.20 or less, preferably 0.02 or more and 0.18 or less, more preferably 0.03 or more and 0.16 or less, and still more preferably 0.04 or more and 0.12 or less.

Accordingly, the above effects are more remarkably exhibited.

The first solid electrolyte usually has a garnet-type crystal structure.

Accordingly, it is possible to achieve both high ion conductivity and electrochemical stability at a higher level, and it is possible to further improve suitability, reliability, and the like of the stacked solid-state battery in a high rate operation.

The stacked solid-state battery according to the present disclosure may contain a plurality of types of first solid electrolytes.

### 1-2 Cell

The cell 10 has a structure in which the positive electrode layer 1, the solid electrolyte layer 3, and the negative electrode layer 2 are stacked in this order.

The stacked solid-state battery 100 may include a plurality of cells 10, and the number of the cells 10 included in the stacked solid-state battery 100 is preferably 2 or more and 2000 or less, and more preferably 3 or more and 1000 or less.

Accordingly, an area per unit volume of the electrode is likely to be increased, and the stacked solid-state battery 100 can be made to have a higher capacity.

A thickness of the cell 10 is not particularly limited, and is preferably 0.01 μm or more and 500 μm or less, and more preferably 0.3 μm or more and 60 μm or less.

Accordingly, it is possible to provide a stacked solid-state battery 100 having both a practically sufficient capacity and a higher charge/discharge operation characteristic.

### 1-2-1 Solid Electrolyte Layer

The solid electrolyte layer 3 is made of a material containing a solid electrolyte.

In particular, the solid electrolyte layer 3 is preferably made of a material containing the above first solid electrolyte. In other words, the first solid electrolyte is preferably contained in the solid electrolyte layer 3.

Accordingly, the ion conductivity of the solid electrolyte layer 3 can be further increased, an interface contact between the positive electrode layer 1 and the negative electrode layer 2 of the solid electrolyte layer 3 can be further increased, and the internal resistance of the stacked solid-state battery 100 can be further reduced.

The content of the first solid electrolyte in the solid electrolyte layer 3 is preferably 10 mass % or more, more preferably 15 mass % or more, and still more preferably 20 mass % or more.

Accordingly, the above effects are more remarkably exhibited.

The solid electrolyte layer 3 may contain a second solid electrolyte having a NASICON-type crystal structure.

In particular, the solid electrolyte layer 3 preferably contains the second solid electrolyte having a NASICON-type crystal structure in addition to the first solid electrolyte.

Accordingly, chemical stability of the solid electrolyte layer 3 with respect to atmospheric components and the like can be increased, and long-term operation reliability of the stacked solid-state battery 100 can be further improved.

The second solid electrolyte is not particularly limited, and is preferably a lithium-containing phosphate compound.

Accordingly, operation reliability of the stacked solid-state battery 100 can be further increased, and by using the first solid electrolyte in combination, the second solid electrolyte functions as a so-called sintering aid that increases the sintering property of the first solid electrolyte, and operation characteristics of the stacked solid-state battery 100 can be further improved.

In particular, as the lithium-containing phosphate compound, a compound represented by the following composition formula (2) can be preferably used.

LiₓM_{y}(PO₄)₃ (2)

(In the formula (2), 1≤x≤2, 1≤y≤2, and M represents at least one element selected from the group consisting of Ti, Ge, Al, Ga, and Zr.)

Accordingly, bulk ion conductivity of the solid electrolyte increases, and the high rate operation characteristics of the stacked solid-state battery 100 can be further improved.

Specific examples of the lithium-containing phosphate compound include, for example, Li_{1.5}Al_{0.5}Ge_{1.5}(PO₄)₃, Li_{1.3}Al_{0.3}Ti_{1.7}(PO₄)₃, Li_{1.3}Ti_{1.7}Al_{0.3}(PO₄)₃, Li_{1.4}Al_{0.4}Ti_{1.6}(PO₄)₃, Li_{1.4}Al_{0.4}Ti_{1.4}Ge_{0.2}(PO₄)₃, Li_{1.5}Al_{0.5}Ge_{1.5}(PO₄)₃, and Li_{1.2}Al_{0.2}Ti_{1.8}(PO₄)₃.

As the second solid electrolyte, two or more types of compounds may be used in combination.

When the second solid electrolyte is contained in the solid electrolyte layer 3, the content of the second solid electrolyte in the solid electrolyte layer 3 is preferably 10 mass % or more and 90 mass % or less, more preferably 30 mass % or more and 85 mass % or less, and still more preferably 50 mass % or more and 80 mass % or less.

Accordingly, three elements of the electrochemical stability, the chemical stability and the ion conductivity of the solid electrolyte can be increased without impairing one another, and the high rate operation characteristics and the long-term operation reliability of the stacked solid-state battery 100 can be further improved.

When the content of the first solid electrolyte in the solid electrolyte layer 3 is X1 [mass %] and the content of the second solid electrolyte in the solid electrolyte layer 3 is X2 [mass %], it is preferable to satisfy 0.10≤X1/X2≤9.0, more preferable to satisfy 0.18≤X1/X2≤2.3, and still more preferably to satisfy 0.25≤X1/X2≤1.0.

Accordingly, the three elements of the electrochemical stability, the chemical stability and the ion conductivity of the solid electrolyte can be increased without impairing one another, and the high rate operation characteristics and the long-term operation reliability of the stacked solid-state battery 100 can be further improved.

The solid electrolyte layer 3 may be made of a material containing a solid electrolyte other than those described above. Examples of such a solid electrolyte include various oxide solid electrolytes other than the above, sulfide solid electrolytes, nitride solid electrolytes, halide solid electrolytes, hydride solid electrolytes, dry polymer electrolytes, crystalline materials and amorphous materials of pseudo-solid electrolytes, and one type or two or more types selected from these electrolytes can be used in combination.

Examples of a crystalline oxide include: Li_{0.35}La_{0.55}TiO₃, Li_{0.2}La_{0.27}NbO₃, and a perovskite type crystal or a perovskite-like crystal in which a part of elements constituting the crystals are substituted by N, F, Al, Sr, Sc, Nb, Ta, Sb, a lanthanoid element, and the like; Li₇La₃Zr₂O₁₂, Li₅La₃Nb₂O₁₂, Li₅BaLa₂TaO₁₂ and a garnet type crystal or a garnet-like crystal in which a part of elements constituting the crystals are substituted by N, F, Al, Sr, Sc, Nb, Ta, Sb, a lanthanoid element, and the like; a LISICON-type crystal such as Li₁₄ZnGe₄O₁₆; and other crystalline materials such as Li_{3.4}V_{0.6}Si_{0.4}O₄, Li_{3.6}V_{0.4}Ge_{0.6}O₄, and Li₂₊ₓC₁₋ₓBₓO₃.

Examples of a crystalline sulfide include Li₁₀GeP₂S₁₂, Li_{9.6}P₃S₁₂, Li_{9.54}Si_{1.74}P_{1.44}S_{11.7}Cl_{0.3}, and Li₃PS₄.

Examples of other amorphous materials include Li₂O—TiO₂, La₂O₃—Li₂O—TiO₂, LiNbO₃, LiSO₄, Li₄SiO₄, Li₃PO₄—Li₄SiO₄, Li₄GeO₄—Li₃VO₄, Li₄SiO₄—Li₃VO₄, Li₄GeO₄—Zn₂GeO₂, Li₄SiO₄—LiMoO₄, Li₄SiO₄—Li₄ZrO₄, SiO₂—P₂O₅—Li₂O, SiO₂—P₂O₅—LiCl, Li₂O—LiCl—B₂O₃, LiAlCl₄, LiAlF₄, LiF—Al₂O₃, LiBr—Al₂O₃, Li_{2.88}PO_{3.73}N_{0.14}, Li₃N—LiCl, Li₆NBr₃, Li₂S—SiS₂, and Li₂S—SiS₂—P₂S₅.

The content of components other than the first solid electrolyte and the second solid electrolyte in the solid electrolyte layer 3 is preferably 10 mass % or less, more preferably 7 mass % or less, and still more preferably 5 mass % or less.

The thickness of the solid electrolyte layer 3 is preferably 0.1 μm or more and 100 μm or less, and more preferably 0.2 μm or more and 10 μm or less.

Accordingly, the internal resistance of the solid electrolyte layer 3 can be further reduced, and an occurrence of a short circuit between the positive electrode layer 1 and the negative electrode layer 2 can be more effectively prevented.

For the purposes of improving the adhesion between the solid electrolyte layer 3 and the positive electrode layer 1, and improving output and a battery capacity of the stacked solid-state battery 100 by increasing a specific surface area, for example, a three-dimensional pattern structure such as dimples, trenches, and pillars may be formed on a surface of the solid electrolyte layer 3 in contact with the positive electrode layer 1.

For the purposes of improving the adhesion between the solid electrolyte layer 3 and the negative electrode layer 2, and improving the output and the battery capacity of the stacked solid-state battery 100 by increasing the specific surface area, for example, a three-dimensional pattern structure such as dimples, trenches, and pillars may be formed on a surface of the solid electrolyte layer 3 in contact with the negative electrode layer 2.

In the plurality of cells 10 constituting the stacked solid-state battery 100, conditions of each solid electrolyte layer 3 may be the same as or different from each other.

### 1-2-2 Positive Electrode Layer

The positive electrode layer 1 may be made of any material as long as the material contains a positive electrode active material.

As the positive electrode active material constituting the positive electrode layer 1, for example, a lithium composite oxide containing at least Li and one or more elements selected from the group consisting of V, Cr, Mn, Fe, Co, Ni, and Cu can be used. Examples of such a composite oxide include LiCoO₂, LiNiO₂, LiMnO₄, Li₂Mn₂O₃, LiCrO_{0.5}Mn_{0.5}O₂, LiFePO₄, Li₂FeP₂O₇, LiMnPO₄, LiFeBO₃, Li₃V₂ (PO₄)₃, Li₂CuO₂, Li₂FeSiO₄, and Li₂MnSiO₄. Examples of the positive electrode active material constituting the positive electrode layer 1 include a fluoride such as LiFeF₃, a boride complex compound such as LiBH₄ and Li₄BN₃H₁₀, an iodine complex compound such as a polyvinylpyridine-iodine complex, and a non-metal compound such as sulfur.

The content of the positive electrode active material in the positive electrode layer 1 is preferably 10 mass % or more, more preferably 25 mass % or more, and still more preferably 40 mass % or more.

The positive electrode layer 1 may contain a solid electrolyte in addition to the positive electrode active material.

Accordingly, an area of a contact interface where charge exchange between the positive electrode active material and the solid electrolyte occurs is increased, and the operation characteristics at a higher rate can be improved.

When the positive electrode layer 1 is made of a material containing a solid electrolyte, for example, the solid electrolyte described as a constituent material of the solid electrolyte layer 3 can be used.

In particular, when the positive electrode layer 1 contains the above first solid electrolyte, a contact interface having a higher adhesion can be suitably formed, and battery characteristics of the stacked solid-state battery 100 can be further increased.

When the positive electrode layer 1 contains the second solid electrolyte described above in addition to the first solid electrolyte, a contact interface having higher adhesion can be suitably formed, higher ion conductivity can be obtained, particularly excellent chemical stability can be further imparted, and the reliability of the stacked solid-state battery 100 can be further improved.

When the first solid electrolyte is contained in the positive electrode layer 1, the content of the first solid electrolyte in the positive electrode layer 1 is preferably 1.25 mass % or more and 75 mass % or less, and more preferably 4 mass % or more and 50 mass % or less.

When the second solid electrolyte is contained in the positive electrode layer 1, the content of the second solid electrolyte in the positive electrode layer 1 is preferably 1.25 mass % or more and 75 mass % or less, and more preferably 4 mass % or more and 50 mass % or less.

The positive electrode layer 1 may contain components other than those described above. Hereinafter, such components are also referred to as “other components”. Examples of the other components include a conductive aid and a binder.

The content of the other components in the positive electrode layer 1 is preferably 10 mass % or less, more preferably 7 mass % or less, and still more preferably 5 mass % or less.

As the conductive aid, any conductor whose electrochemical interaction can be ignored at a positive electrode reaction potential may be used. More specifically, examples of the conductive aid include carbon materials such as acetylene black, Ketjen black, and carbon nanotubes, precious metals such as palladium and platinum, and conductive oxides such as SnO₂, ZnO, RuO₂ or ReO₃, and Ir₂O₃.

The thickness of the positive electrode layer 1 is not particularly limited, and is preferably 0.1 μm or more and 500 μm or less, and more preferably 0.3 μm or more and 100 μm or less.

In the plurality of cells 10 constituting the stacked solid-state battery 100, the conditions of each positive electrode layer 1 may be the same as or different from each other.

### 1-2-3 Negative Electrode Layer

The negative electrode layer 2 may be made of any material as long as the material contains a negative electrode active material.

Examples of the negative electrode active material constituting the negative electrode layer 2 include Nb₂O₅, V₂O₅, TiO₂, In₂O₃, ZnO, SnO₂, NiO, ITO, AZO, GZO, ATO, FTO, and lithium composite oxides such as Li₄Ti₅O₁₂ and Li₂Ti₃O₇. Examples of the negative electrode active material further include metals or alloys such as Li, Al, Si, Si—Mn, Si—Co, Si—Ni, Sn, Zn, Sb, Bi In, and Au, carbon materials, substances in which lithium ions are inserted between layers of carbon materials, such as LiC₂₄ and LiC₆.

The content of the negative electrode active material in the negative electrode layer 2 is preferably 3 mass % or more, more preferably 20 mass % or more, and still more preferably 32 mass % or more.

The negative electrode layer 2 may contain a solid electrolyte in addition to the negative electrode active material.

Accordingly, an area of a contact interface where charge exchange between the negative electrode active material and the solid electrolyte occurs is increased, and the operation characteristics at a higher rate can be improved.

When the negative electrode layer 2 is made of a material containing a solid electrolyte, for example, the solid electrolyte described as the constituent material of the solid electrolyte layer 3 can be used.

In particular, when the negative electrode layer 2 contains the above first solid electrolyte, the contact interface having a higher adhesion can be suitably formed, and the battery characteristics of the stacked solid-state battery 100 can be further increased.

When the negative electrode layer 2 contains the second solid electrolyte described above in addition to the first solid electrolyte, a contact interface having higher adhesion can be suitably formed, higher ion conductivity can be obtained, particularly excellent chemical stability can be further imparted, and reliability of the stacked solid-state battery 100 can be further improved.

When the first solid electrolyte is contained in the negative electrode layer 2, the content of the first solid electrolyte in the negative electrode layer 2 is preferably 1.25 mass % or more and 75 mass % or less, and more preferably 4 mass % or more and 50 mass % or less.

When the second solid electrolyte is contained in the negative electrode layer 2, the content of the second solid electrolyte in the negative electrode layer 2 is preferably 1.25 mass % or more and 75 mass % or less, and more preferably 4 mass % or more and 50 mass % or less.

The negative electrode layer 2 may contain components other than those described above. Hereinafter, such components are also referred to as “other components”. Examples of the other components include a conductive aid and a binder.

The content of the other components in the negative electrode layer 2 is preferably 10 mass % or less, more preferably 7 mass % or less, and still more preferably 5 mass % or less.

As the conductive aid, any conductor whose electrochemical interaction can be ignored at a negative electrode reaction potential may be used. More specifically, examples of the conductive aid include carbon materials such as acetylene black, Ketjen black, and carbon nanotubes, precious metals such as palladium and platinum, and conductive oxides such as SnO₂, ZnO, RuO₂ or ReO₃, and Ir₂O₃.

The thickness of the negative electrode layer 2 is not particularly limited, and is preferably 0.1 μm or more and 500 μm or less, and more preferably 0.3 μm or more and 100 μm or less.

In the plurality of cells 10 constituting the stacked solid-state battery 100, the conditions of each negative electrode layer 2 may be the same as or different from each other.

### 1-3 Internal Current Collecting Layer

The stacked solid-state battery 100 according to the present embodiment includes the internal current collecting layer 4a or the internal current collecting layer 4b between the adjacent cells 10. In other words, the internal current collecting layers 4a and 4b are in contact with electrodes of the cells 10 on a first surface that is one surface, and are in contact with electrodes of the cells 10, which are different from the electrodes in contact with the first surface, on a second surface that is the other surface.

The electrodes of the cells 10 in contact with the first surface and the electrodes of the cells 10 in contact with the second surface have the same polarity. That is, in the internal current collecting layer 4a in which the electrode in contact with the first surface is the positive electrode layer 1, the electrode in contact with the second surface is also the positive electrode layer 1, and in the internal current collecting layer 4b in which the electrode in contact with the first surface is the negative electrode layer 2, the electrode in contact with the second surface is also the negative electrode layer 2.

By providing such internal current collecting layers 4a and 4b, an electron transfer resistance with the electrodes can be reduced, and the internal resistance of the stacked solid-state battery 100 can be made lower.

The internal current collecting layer 4a and the internal current collecting layer 4b may contain a conductive material which is an ion conductive material.

Examples of the conductive material constituting the internal current collecting layer 4a and the internal current collecting layer 4b include a lithium-containing phosphate compound represented by the composition formula (2), perovskite-type titanium lanthanum lithium, garnet-type lanthanum lithium zirconate, and a reverse perovskite-type compound, one type or two or more types selected from these materials can be used in combination, and the lithium-containing phosphate compound represented by the above composition formula (2) is particularly preferable.

Accordingly, the chemical stability with respect to atmospheric components and the like can be increased, and the long-term operation reliability of the stacked solid-state battery 100 can be further improved.

The content of the conductive material in the internal current collecting layer 4a and the internal current collecting layer 4b is preferably 0.01 mass % or more, more preferably 0.05 mass % or more, and still more preferably 0.1 mass % or more.

The internal current collecting layer 4a and the internal current collecting layer 4b may contain the above first solid electrolyte in addition to the conductive material.

Accordingly, the electron transfer resistance with the electrodes can be reduced, and the internal resistance of the stacked solid-state battery 100 can be made lower.

When the first solid electrolyte is contained in the internal current collecting layer 4a, the content of the first solid electrolyte in the internal current collecting layer 4a is preferably 0.01 mass % or more and 0.5 mass % or less, and more preferably 0.05 mass % or more and 0.1 mass % or less. The same applies to the internal current collecting layer 4b.

The thickness of the internal current collecting layer 4a or the internal current collecting layer 4b is not particularly limited, and is preferably 0.01 μm or more and 50 μm or less, and more preferably 0.1 μm or more and 20 μm or less.

When the stacked solid-state battery 100 includes a plurality of internal current collecting layers, the conditions of each internal current collecting layer may be the same as or different from each other.

### 1-4 External Electrode

In the present embodiment, external electrodes are provided on surfaces of both outermost layers in a stacking direction of a stacked body formed by stacking the plurality of cells 10, that is, the stacked body in which the stacked solid-state battery 100 is composed of n cells 10 and (n−1) internal current collecting layers when n is an integer of 2 or more. In particular, the stacked solid-state battery 100 according to the present embodiment includes an odd number of cells 10, an external electrode 5a is provided on the surface of the positive electrode layer 1 which is one outer surface of the stacked body in the stacking direction, and an external electrode 5b is provided on the surface of the negative electrode layer 2 which is the other outer surface of the stacked body in the stacking direction.

In the stacked solid-state battery 100 according to the present embodiment, charging and discharging can be performed by coupling the external electrode 5a and each internal current collecting layer 4a to a positive electrode terminal (not shown) and coupling the external electrode 5b and each internal current collecting layer 4b to a negative electrode terminal (not shown).

The external electrode 5a and the external electrode 5b may be made of a material having electron conductivity. Examples of a constituent material of the external electrode 5a and the external electrode 5b include metal materials such as Al, Ti, Pt, Au, and Cu.

### 1-5 Others

A shape of the stacked solid-state battery 100 may be any shape, such as a disc shape or a polygonal shape. A size of the stacked solid-state battery 100 is not particularly limited, and for example, a diameter of the stacked solid-state battery 100 can be, for example, 10 mm or more and 20 mm or less, and the thickness of the stacked solid-state battery 100 can be, for example, 0.1 mm or more and 1.0 mm or less.

When the stacked solid-state battery 100 is small and thin as described above, the stacked solid-state battery 100 is chargeable and dischargeable, is an all solid, and can be suitably used as a power source of a mobile information terminal such as a smartphone.

The stacked solid-state battery 100 may be used in any application. Examples of an electronic device to which the stacked solid-state battery 100 is applied as the power source include a personal computer, a digital camera, a mobile phone, a smartphone, a music player, a tablet terminal, a watch, a smart watch, various printers such as an inkjet printer, a television, a projector, a head-up display, wearable terminals such as wireless headphones, wireless earphones, smart glasses, and a head mounted display, a video camera, a video tape recorder, a car navigation device, a drive recorder, a pager, an electronic notebook, an electronic dictionary, an electronic translator, a calculator, an electronic game device, a toy, a word processor, a workstation, a robot, a video phone, a security television monitor, electronic binoculars, a POS terminal, a medical device, a fish finder, various measuring devices, a mobile terminal base station device, various meters and gauges for a vehicle, a railway vehicle, an aircraft, a helicopter, a ship, and the like, a flight simulator, and a network server. The stacked solid-state battery 100 may be applied to, for example, a moving object such as an automobile or a ship. More specifically, the stacked solid-state battery 100 can be suitably applied as a storage battery for an electric vehicle, a plug-in hybrid vehicle, a hybrid vehicle, or a fuel cell vehicle. In addition, the stacked solid-state battery 100 can also be applied as a household power source, an industrial power source, a solar power storage battery, and the like.

### 2 Second Embodiment

Next, a stacked solid-state battery according to a second embodiment will be described.

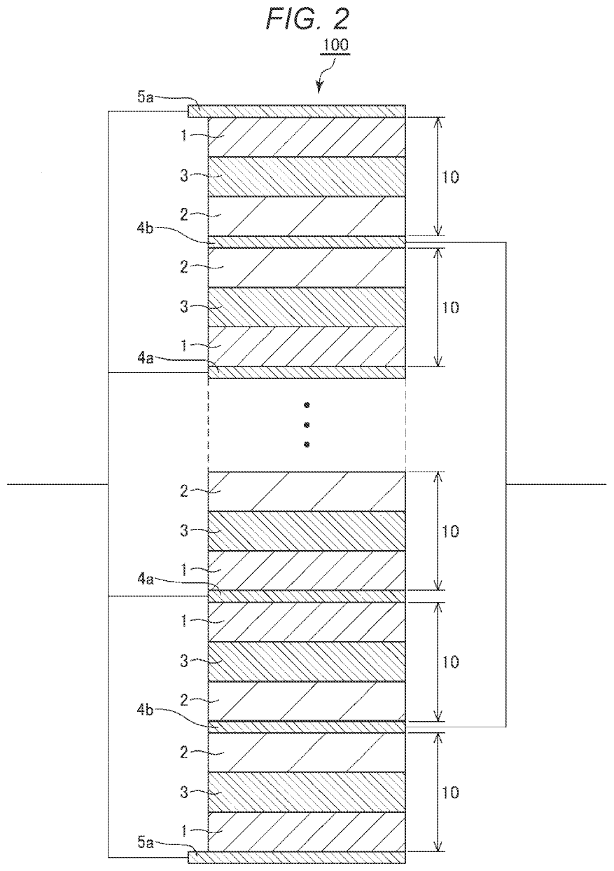

FIG. 2 is a cross-sectional view schematically showing a cross-sectional structure of the stacked solid-state battery according to the second embodiment.

Hereinafter, the stacked solid-state battery according to the second embodiment will be described with reference to the FIG. 2. Differences from the embodiment described above will be mainly described, and description of the same matters will be omitted.

In the first embodiment described above, the stacked solid-state battery 100 includes an odd number of cells 10. In the stacked body constituting the stacked type solid-state battery 100, that is, the stacked body formed by stacking the plurality of cells 10, one outer surface in the stacking direction is the surface of the positive electrode layer 1, and the other outer surface in the stacking direction is the surface of the negative electrode layer 2. That is, in the first embodiment described above, both outer surfaces of the stacked body in the stacking direction are electrodes having different polarities from each other. In contrast, in the present embodiment, the stacked solid-state battery 100 includes an even number of cells 10. In the stacked body constituting the stacked type solid-state battery 100, that is, the stacked body formed by stacking the plurality of cells 10, both outer surfaces of the stacked body in the stacking direction are electrodes having the same polarity. In particular, in the illustrated configuration, each of the both outer surfaces of the stacked body in the stacking direction is the positive electrode layer 1. The external electrode 5a is provided on each of the surfaces of the positive electrode layers 1 provided on the both outer surfaces of the stacked body in the stacking direction.

In the stacked solid-state battery 100 according to the present embodiment, charging and discharging can be performed by coupling the external electrode 5a and each internal current collecting layer 4a to a positive electrode terminal (not shown) and coupling each internal current collecting layer 4b to a negative electrode terminal (not shown).

When each of the both outer surfaces of the stacked body in the stacking direction is the negative electrode layer 2, the external electrode 5b may be provided on each of the surfaces of the negative electrode layers 2 provided on the both outer surfaces of the stacked body in the stacking direction. In such a stacked solid-state battery 100, charging and discharging can be performed by coupling each internal current collecting layer 4a to a positive electrode terminal (not shown) and coupling the external electrode 5b and each internal current collecting layer 4b to a negative electrode terminal (not shown).

### 3 Third Embodiment

Next, a stacked solid-state battery according to a third embodiment will be described.

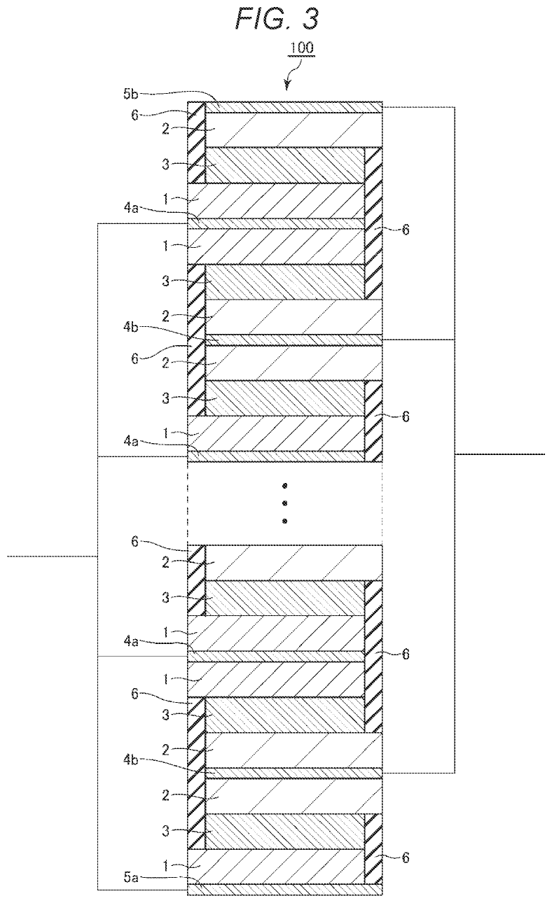

FIG. 3 is a cross-sectional view schematically showing a cross-sectional structure of the stacked solid-state battery according to the third embodiment.

Hereinafter, the stacked solid-state battery according to the third embodiment will be described with reference to the FIG. 3. The differences from the embodiments described above will be mainly described, and description of the same matters will be omitted.

As shown in FIG. 3, the stacked solid-state battery 100 according to the present embodiment includes an odd number of cells 10, and protective layers 6 are disposed on side surfaces.

Accordingly, contact between the positive electrode layer 1 and the negative electrode layer 2 on the side surface of the stacked solid-state battery 100 can be effectively prevented, and the occurrence of a problem such as a short circuit can be more reliably prevented.

In the illustrated configuration, the entire side surface of the solid electrolyte layer 3 and a part of side surfaces of the positive electrode layer 1, the negative electrode layer 2 and the internal current collecting layers 4a and 4b are covered with the protective layers 6. Accordingly, the above effects are more remarkably exhibited, and coupling to a positive electrode terminal and a negative electrode terminal (not shown) can be suitably performed in a portion of the side surfaces of the stacked solid-state battery 100 where the protective layers 6 are not disposed.

Depending on the shape of the stacked solid-state battery 100, for example, when the stacked solid-state battery 100 has a disc shape, it is preferable that portions of the side surfaces of the positive electrode layer 1 and the internal current collecting layer 4a that are not covered with the protective layers 6 and portions of the side surfaces of the negative electrode layer 2 and the internal current collecting layer 4b that are not covered with the protective layers 6 are positioned opposite with respect a center axis of the disc.

Examples of the constituent material of the protective layer 6 include various resin materials such as an epoxy resin, a polyamide, and a polyester, and a composite material obtained by adding a predetermined filler thereto.

A thickness of the protective layer 6 is not particularly limited, and is preferably 0.1 μm or more and 100 μm or less, and more preferably 1 μm or more and 50 μm or less.

When the stacked solid-state battery 100 includes a plurality of protective layers 6, conditions of each protective layer 6 may be the same as or different from each other.

The stacked solid-state battery 100 according to the present embodiment has the same configuration as that of the first embodiment except that the protective layers 6 are provided.

### 4 Fourth Embodiment

Next, a stacked solid-state battery according to a fourth embodiment will be described.

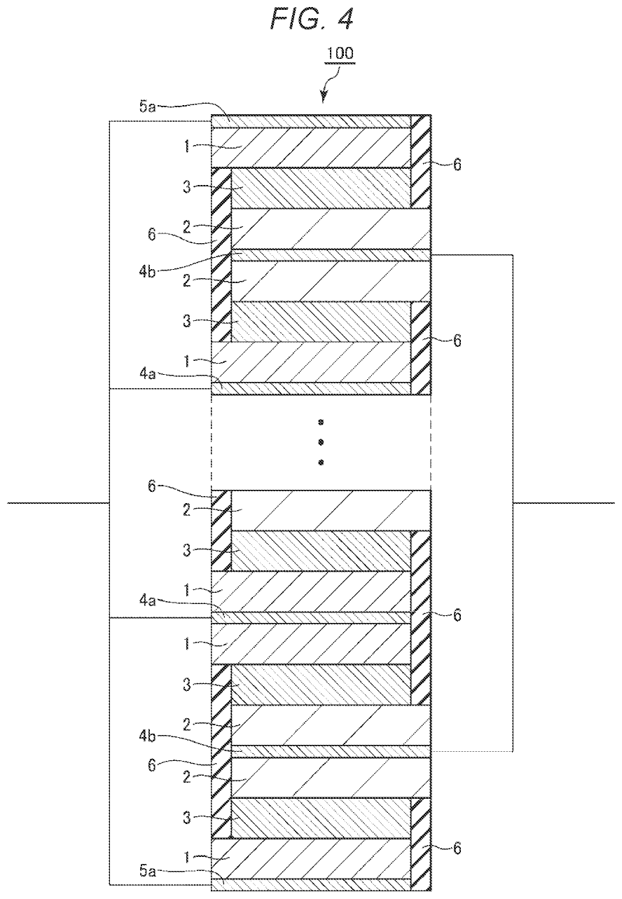

FIG. 4 is a cross-sectional view schematically showing a cross-sectional structure of the stacked solid-state battery according to the fourth embodiment.

Hereinafter, the stacked solid-state battery according to the fourth embodiment will be described with reference to the FIG. 4. The differences from the embodiment described above will be mainly described, and the description of the same matters will be omitted.

As shown in FIG. 4, the stacked solid-state battery 100 according to the present embodiment includes an even number of cells 10, and the protective layers 6 are disposed on the side surfaces of the positive electrode layer 1 and the negative electrode layer 2. That is, the present embodiment is the same as the second embodiment except that the protective layers 6 are provided.

The conditions of the protective layer 6, for example, the portions where the protective layers 6 are provided, the constituent materials, and the thickness are preferably the same as those described in the third embodiment.

### 5 Fifth Embodiment

Next, a stacked solid-state battery according to a fifth embodiment will be described.

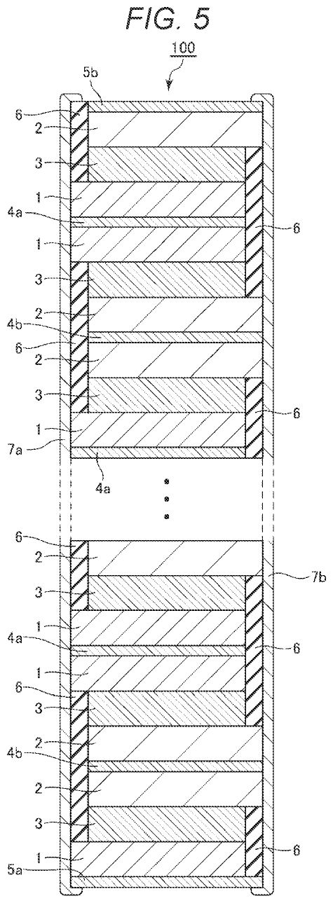

FIG. 5 is a cross-sectional view schematically showing a cross-sectional structure of the stacked solid-state battery according to the fifth embodiment.

Hereinafter, the stacked solid-state battery according to the fifth embodiment will be described with reference to the FIG. 5. The differences from the embodiments described above will be mainly described, and description of the same matters will be omitted.

As shown in FIG. 5, the stacked solid-state battery 100 according to the present embodiment includes an odd number of cells 10, and an external current collecting layer 7a and an external current collecting layer 7b having electron conductivity are provided on the side surfaces of the stacked solid-state battery 100. The external current collecting layer 7a is electrically coupled to the side surface of the positive electrode layer 1 and the side surface of the internal current collecting layer 4a, and the external current collecting layer 7b is electrically coupled to the side surface of the negative electrode layer 2 and the side surface of the internal current collecting layer 4b.

With such a configuration, the external current collecting layer 7a can be used as a positive electrode terminal, and the external current collecting layer 7b can be used as a negative electrode terminal.

As the constituent material of the external current collecting layers 7a and 7b, for example, a material having electron conductivity such as various metal materials and carbon materials can be suitably used.

A thickness of the external current collecting layer 7a or 7b is not particularly limited, and is preferably 0.1 μm or more and 200 μm or less, and more preferably 0.5 μm or more and 50 μm or less.

The stacked solid-state battery 100 according to the present embodiment has the same configuration as that of the third embodiment except that the external current collecting layers 7a and 7b are provided.

Even when the external current collecting layer 7a is coupled to only one of the positive electrode layer 1 and the internal current collecting layer 4a or even when the external current collecting layer 7b is coupled to only one of the negative electrode layer 2 and the internal current collecting layer 4b, the same effect as described above can be obtained.

### 6 Sixth Embodiment

Next, a stacked solid-state battery according to a sixth embodiment will be described.

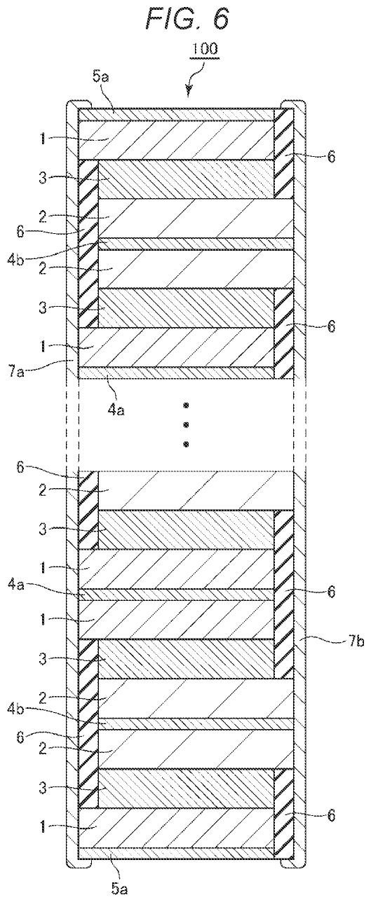

FIG. 6 is a cross-sectional view schematically showing a cross-sectional structure of the stacked solid-state battery according to the sixth embodiment.

Hereinafter, the stacked solid-state battery according to the sixth embodiment will be described with reference to the FIG. 6. The differences from the embodiments described above will be mainly described, and description of the same matters will be omitted.

As shown in FIG. 6, the stacked solid-state battery 100 according to the present embodiment includes an even number of cells 10, and the external current collecting layer 7a and the external current collecting layer 7b having electron conductivity are provided on the side surfaces of the stacked solid-state battery 100. The external current collecting layer 7a is electrically coupled to the side surface of the positive electrode layer 1 and the side surface of the internal current collecting layer 4a, and the external current collecting layer 7b is electrically coupled to the side surface of the negative electrode layer 2 and the side surface of the internal current collecting layer 4b. That is, the present embodiment is the same as the fourth embodiment except that the external current collecting layers 7a and 7b are provided.

The conditions of the external current collecting layers 7a and 7b are preferably the same as those described in the fifth embodiment.

Although the preferred embodiments according to the present disclosure have been described above, the present disclosure is not limited thereto.

For example, the stacked solid-state battery according to the present disclosure may further have another configuration in addition to the configuration described above.

In the drawings referred to in the embodiments described above, the stacked solid-state battery includes five or more cells, but the stacked solid-state battery according to the present disclosure may include two or more cells, and the number of the included cells may be four or less.

In the embodiments described above, a case where the external electrodes are provided on the outer surfaces on both sides of the stacked body in the stacking direction has been described, but at least one of such external electrodes may be omitted.

In the above embodiments, a case where the internal current collecting layer is provided between adjacent cells in the stacking direction has been described as a representative example, but the internal current collecting layer may be omitted. For example, in adjacent cells in the stacking direction, the internal current collecting layer may be omitted by sharing electrodes of the same polarity, that is, the positive electrode layer or the negative electrode layer.

### EXAMPLES

Next, specific examples according to the present disclosure will be described.

### 7 Manufacturing of Stacked Solid-state Battery

### Example A1

Li₂O, La₂O₃, ZrO₂, Ga₂O₃, and Nd₂O₃ (all manufactured by Kojundo Chemical Co., Ltd.) were weighed at a ratio of 1.001 parts by mass, 4.871 parts by mass, 2.464 parts by mass, 0.094 parts by mass, and 0.017 parts by mass, respectively, and these components were mixed in an agate bowl, molded into a pellet shape at 624 MPa, and fired at 1000° C. for 6 hours in an air atmosphere. Then, the fired product was grinded, to obtain a powdery first solid electrolyte having a garnet-type crystal structure and having a composition formula: (Li_{6.7}Ga_{0.1}) (La_{2.99}Nd_{0.01})Zr₂O₁₂.

A solid electrolyte paste, i.e., a paste for forming the solid electrolyte layer, was manufactured as follows.

That is, 100 g of a solution, prepared by dissolving 15 g of polyvinyl butyral and 5 g of benzyl butyl phthalate in 80 g of ethanol, and 15 g of the above powdery first solid electrolyte were mixed and slurried to obtain a solid electrolyte paste.

A positive electrode paste, i.e., a paste for forming the positive electrode layer, was manufactured as follows.

That is, 100 g of a solution, prepared by dissolving 10 g of polypropylene carbonate (manufactured by Sigma-Aldrich) in 90 g of 1,4-dioxane (manufactured by Kanto Chemical Cop., Inc.), 6.0 g of LiCoO₂ powder (manufactured by Nippon Kayaku Cop., Ltd.), as a positive electrode active material, and 4.0 g of the powdery first solid electrolyte were mixed and slurried to obtain a positive electrode paste.

A negative electrode paste, i.e., a paste for forming the negative electrode layer, was manufactured as follows.

That is, 100 g of a solution, prepared by dissolving 10 g of polypropylene carbonate (manufactured by Sigma-Aldrich) in 90 g of 1,4-dioxane (manufactured by Kanto Chemical Cop., Inc.), 6.0 g of TiO₂ powder (manufactured by Sigma-Aldrich), as a negative electrode active material, and 4.0 g of the powdery first solid electrolyte were mixed and slurried to obtain a negative electrode paste.

The solid electrolyte paste obtained as described above was subjected to sheet molding on a polyethylene terephthalate film base material using a total automatic film applicator (manufactured by COTEC Corporation). Then, the sheet was dried under a reduced pressure at 80° C. for 3 hours to obtain a green sheet for forming the solid electrolyte layer.

Next, the positive electrode paste obtained as described above was screen-printed on the green sheet for forming the solid electrolyte layer thus obtained so as to have a rectangular shape of 9 mm×9 mm, and dried under a reduced pressure at 80° C. for 3 hours, to obtain a stacked body of the green sheet for forming the solid electrolyte layer and a green sheet for forming the positive electrode layer.

Next, the negative electrode paste obtained as described above was screen-printed on a surface of a green sheet for forming the positive electrode layer of the stacked body of the green sheet for forming the solid electrolyte layer and the green sheet for forming the positive electrode layer thus obtained, and dried under a reduced pressure at 80° C. for 3 hours, to obtain a stacked body of the green sheet for forming the positive electrode layer, the green sheet for forming the solid electrolyte layer and the green sheet for forming the negative electrode layer.

A Ni paste (manufactured by Daiken Chemical Cop., Ltd.) was screen-printed on both surfaces of the stacked body of the green sheet for forming the positive electrode layer, the green sheet for forming the solid electrolyte layer, and the green sheet for forming the negative electrode layer, and dried under a reduced pressure at 80° C. for 3 hours to form a layer to be an internal current collecting electrode, and to obtain a precursor of the cell.

The precursor of the cell prepared as described above was cut into a size of 10 mm×10 mm such that one side of an electrode printing region was shared with a cut end surface, precursors of individual battery bodies were aligned such that polarities of adjacent electrodes were the same, stacking was made with 20 layers such that end surfaces of the green sheets for forming the positive electrode layer and end surfaces of the green sheets for forming the negative electrode layer did not coincide with each other, and then thermocompression bonding was performed at 50° C. to 95° C. and 100 MPa to prepare a stacked body.

Next, the stacked body was sintered in an air atmosphere at 900° C. for 6 hours. Then, a firing atmosphere was changed to argon gas containing 3 mass % of hydrogen gas, and the stacked body was fired at 900° C. for 1 hour, slowly cooled, and then taken out. Next, a AgZn paste was applied to an exposed portion of the end surface of the electrode layer of the stacked body and annealing was performed at 400° C. to form an external electrode, and to obtain a stacked solid-state battery having a theoretical capacity of 3.3 mAh.

### Examples A2 to A5

A stacked solid-state battery was manufactured in the same manner as in Example A1, except that the type and the use ratio of the raw material compounds used in the manufacturing of the first solid electrolyte were as shown in Table 1, and the composition of the first solid electrolyte was as shown in Table 3.

### Examples B1 to B3

A stacked solid-state battery was manufactured in the same manner as in Example A3, except that a configuration of the positive electrode layer was as shown in Table 3 by changing a ratio of the positive electrode active material to the first solid electrolyte used in the manufacturing of the positive electrode paste.

### Examples C1 to C3

A stacked solid-state battery was manufactured in the same manner as in Example A3, except that a configuration of the negative electrode layer was as shown in Tables 3 and 4 by changing a ratio of the negative electrode active material to the first solid electrolyte used in the manufacturing of the negative electrode paste.

### Examples D1 to D3

A stacked solid-state battery was manufactured in the same manner as in Example A3, except that the configuration of the negative electrode layer was as shown in Table 4 by using Li₄Ti₄O₁₂ powder instead of the TiO₂ powder as the negative electrode active material and changing the ratio of the negative electrode active material to the first solid electrolyte used in the manufacturing of the negative electrode paste.

### Examples E1 to E3

A stacked solid-state battery was manufactured in the same manner as in Example A3, except that the configuration of the negative electrode layer was as shown in Table 4 by using Nb₂O₅ powder instead of the TiO₂ powder as the negative electrode active material and changing the ratio of the negative electrode active material to the first solid electrolyte used in the manufacturing of the negative electrode paste.

### Examples F1 to F3

A stacked solid-state battery was manufactured in the same manner as in Example A3, except that the configuration of the positive electrode layer was as shown in Table 4 by using LiNi_{0.5}Co_{0.2}Mn_{0.3}O₂ powder instead of the LiCoO₂ powder as the positive electrode active material and changing the ratio of the positive electrode active material to the first solid electrolyte used in the manufacturing of the positive electrode paste.

### Examples G1 to G3

A stacked solid-state battery was manufactured in the same manner as in Example A3, except that the configuration of the positive electrode layer was as shown in Table 5 by using Li₃V₂(PO₄)₃ powder instead of the LiCoO₂ powder as the positive electrode active material and changing the ratio of the positive electrode active material to the first solid electrolyte used in the manufacturing of the positive electrode paste.

### Examples H1 to H3

A stacked solid-state battery was manufactured in the same manner as in Example A3, except that the configuration of the positive electrode layer was as shown in Table 5 by using Li₃V_{1.6}Al_{0.4}(PO₄)₃ powder instead of the LiCoO₂ powder as the positive electrode active material and changing the ratio of the positive electrode active material to the first solid electrolyte used in the manufacturing of the positive electrode paste.

### Example I1

A stacked solid-state battery was manufactured in the same manner as in Example C2, except that a powdery first solid electrolyte manufactured as described below was used.

That is, in this example, the powdery first solid electrolyte was manufactured as follows.

First, LiNO₃, La(NO₃)₃, Zr(OC₄H₉)₄, Ga(NO₃)₃-nH₂O, and Nd(NO₃)₃.6H₂O were separately dissolved in butoxyethanol, and butoxyethanol solutions of the five metal salts each having a concentration of 1 mol/kg were prepared. These five butoxyethanol solutions were mixed at a predetermined ratio, dried at 200° C. for 1 hour, and thermally decomposed at 540° C. for 10 minutes. Then, the residue after the thermal decomposition was grinded and mixed, pressed at 400 MPa, and fired at 900° C. for 4 hours to prepare a sintered body. Then, the sintered body was grinded, to obtain a powdery first solid electrolyte represented by a composition formula: (Li_{5.5}Ga_{0.5}) (La_{2.95}Nd_{0.05})Zr₂O₁₂.

### Example 12

A stacked solid-state battery was manufactured in the same manner as in Example C2, except that a powdery first solid electrolyte manufactured as described below was used.

That is, in this example, the powdery first solid electrolyte was manufactured as follows.

First, LiNO₃, La(NO₃)₃, Zr(OC₄H₉)₄, Ga(NO₃)₃-nH₂O, and Nd(NO₃)₃.6H₂O were separately dissolved in butoxyethanol, and butoxyethanol solutions of the five metal salts each having a concentration of 1 mol/kg were prepared. These five butoxyethanol solutions were mixed at a predetermined ratio, dried at 200° C. for 1 hour, and then thermally decomposed at 540° C. for 10 minutes to obtain a powdery first solid electrolyte.

### Example J1

A stacked solid-state battery was manufactured in the same manner as in Example C2, except that a mixed powder of the powdery first solid electrolyte and a powdery second solid electrolyte prepared as follows was used instead of the powdery first solid electrolyte in the preparation of the solid electrolyte paste, the positive electrode paste and the negative electrode paste.

The powdery second solid electrolyte was manufactured as follows. That is, first, Li₂O, Al₂O₃, GeO₂, and P₂O₅ (all manufactured by Kojundo Chemical Cop., Ltd.) were weighed at a ratio of 0.224 parts by mass, 0.255 parts by mass, 1.569 parts by mass, and 2.129 parts by mass, respectively, and these components were mixed in an agate pot, molded into a pellet shape at 624 MPa, and fired at 1200° C. for 6 hours in an air atmosphere. Then, the fired product was grinded, to obtain a powdery second solid electrolyte having a NASICON-type crystal structure and having a composition formula: Li_{1.5}Al_{0.5}Ge_{1.5}(PO₄)₃.

The mixed powder contained the first solid electrolyte and the second solid electrolyte in a mass ratio of 10:90.

### Examples J2 to J9

A stacked solid-state battery was manufactured in the same manner as in Example J1, except that a mixing ratio of the powdery first solid electrolyte and the powdery second solid electrolyte in the mixed powder was changed as shown in Tables 5 and 6.

### Comparative Examples 1 to 3

A stacked solid-state battery was manufactured in the same manner as in Example A3, except that the use ratio of the raw material compounds used in the manufacturing of the first solid electrolyte was as shown in Table 2, and the composition of the first solid electrolyte was as shown in Table 7.

### Comparative Example 4

A stacked solid-state battery was manufactured in the same manner as in Example J1, except that the first solid electrolyte was not used.

In the manufacturing of the stacked solid-state batteries of the respective Examples and Comparative Examples, the types and use amounts of the raw material compounds in the preparation of the first solid electrolyte are collectively shown in Tables 1 and 2, and configurations of the stacked solid batteries of the respective Examples and Comparative Examples are collectively shown in Tables 3 to 7. Each of the first solid electrolytes constituting the solid electrolyte layers of the respective Examples had a garnet-type crystal structure, and each of the second solid electrolytes constituting the solid electrolyte layers of the respective Examples had a NASICON-type crystal structure. The crystal structure of the first solid electrolyte and the second solid electrolyte was determined from an X-ray diffraction pattern obtained by an analysis using an X-ray diffractometer X'Pert-PRO manufactured by Philips Cop., Ltd.

TABLE 1

| | Raw material compound [parts by mass] | | | | | | | | | |
|---|---|---|---|---|---|---|---|---|---|---|
| | Li₂O | La₂O₃ | ZrO₂ | Ga₂O₃ | Nd₂O₃ | LiNO₃ | La(NO₃)₃ | Zr(OC₄H₉)₄ | Ga(NO₃)₃•nH₂O | Nd(NO₃)₃•6H₂O |
| Example A1 | 1.001 | 4.871 | 2.464 | 0.094 | 0.017 | — | — | — | — | — |
| Example A2 | 1.001 | 4.887 | 2.464 | 3.187 | 0.168 | — | — | — | — | — |
| Example A3 | 0.964 | 4.887 | 2.464 | 2.718 | 0.841 | — | — | — | — | — |
| Example A4 | 0.895 | 4.887 | 2.464 | 1.856 | 1.682 | — | — | — | — | — |
| Example A5 | 0.867 | 4.887 | 2.464 | 1.500 | 1.682 | — | — | — | — | — |
| Example B1 | 0.964 | 4.887 | 2.464 | 2.718 | 0.841 | — | — | — | — | — |
| Example B2 | 0.964 | 4.887 | 2.464 | 2.718 | 0.841 | — | — | — | — | — |
| Example B3 | 0.964 | 4.887 | 2.464 | 2.718 | 0.841 | — | — | — | — | — |
| Example C1 | 0.964 | 4.887 | 2.464 | 2.718 | 0.841 | — | — | — | — | — |
| Example C2 | 0.964 | 4.887 | 2.464 | 2.718 | 0.841 | — | — | — | — | — |
| Example C3 | 0.964 | 4.887 | 2.464 | 2.718 | 0.841 | — | — | — | — | — |
| Example D1 | 0.964 | 4.887 | 2.464 | 2.718 | 0.841 | — | — | — | — | — |
| Example D2 | 0.964 | 4.887 | 2.464 | 2.718 | 0.841 | — | — | — | — | — |
| Example D3 | 0.964 | 4.887 | 2.464 | 2.718 | 0.841 | — | — | — | — | — |
| Example E1 | 0.964 | 4.887 | 2.464 | 2.718 | 0.841 | — | — | — | — | — |
| Example E2 | 0.964 | 4.887 | 2.464 | 2.718 | 0.841 | — | — | — | — | — |
| Example E3 | 0.964 | 4.887 | 2.464 | 2.718 | 0.841 | — | — | — | — | — |
| Example F1 | 0.964 | 4.887 | 2.464 | 2.718 | 0.841 | — | — | — | — | — |
| Example F2 | 0.964 | 4.887 | 2.464 | 2.718 | 0.841 | — | — | — | — | — |
| Example F3 | 0.964 | 4.887 | 2.464 | 2.718 | 0.841 | — | — | — | — | — |
| Example G1 | — | — | — | — | — | — | — | — | — | — |

TABLE 2

| | Raw material compound [parts by mass] | | | | | | | | | |
|---|---|---|---|---|---|---|---|---|---|---|
| | Li₂O | La₂O₃ | ZrO₂ | Ga₂O₃ | Nd₂O₃ | LiNO₃ | La(NO₃)₃ | Zr(OC₄H₉)₄ | Ga(NO₃)₃•nH₂O | Nd(NO₃)₃•6H₂O |
| Example G2 | 0.964 | 4.887 | 2.464 | 2.718 | 0.841 | — | — | — | — | — |
| Example G3 | 0.964 | 4.887 | 2.464 | 2.718 | 0.841 | — | — | — | — | — |
| Example H1 | 0.964 | 4.887 | 2.464 | 2.718 | 0.841 | — | — | — | — | — |
| Example H2 | 0.964 | 4.887 | 2.464 | 2.718 | 0.841 | — | — | — | — | — |
| Example H3 | 0.964 | 4.887 | 2.464 | 2.718 | 0.841 | — | — | — | — | — |
| Example I1 | — | — | — | — | — | 1.896 | 6.387 | 3.837 | 0.887 | 0.110 |
| Example I2 | — | — | — | — | — | 1.896 | 6.387 | 3.837 | 0.887 | 0.110 |
| Example J1 | 0.964 | 4.887 | 2.464 | 2.718 | 0.841 | — | — | — | — | — |
| Example J2 | 0.964 | 4.887 | 2.464 | 2.718 | 0.841 | — | — | — | — | — |
| Example J3 | 0.964 | 4.887 | 2.464 | 2.718 | 0.841 | — | — | — | — | — |
| Example J4 | 0.964 | 4.887 | 2.464 | 2.718 | 0.841 | — | — | — | — | — |
| Example J5 | 0.964 | 4.887 | 2.464 | 2.718 | 0.841 | — | — | — | — | — |
| Example J6 | 0.964 | 4.887 | 2.464 | 2.718 | 0.841 | — | — | — | — | — |
| Example J7 | 0.964 | 4.887 | 2.464 | 2.718 | 0.841 | — | — | — | — | — |
| Example J8 | 0.964 | 4.887 | 2.464 | 2.718 | 0.841 | — | — | — | — | — |
| Example J9 | 0.964 | 4.887 | 2.464 | 2.718 | 0.841 | — | — | — | — | — |
| Comparative | 1.044 | 4.887 | 2.464 | 3.730 | 0.008 | — | — | — | — | — |
| Example 1 | | | | | | | | | | |
| Comparative | 0.970 | 4.887 | 2.464 | 2.802 | 0.841 | — | — | — | — | — |
| Example 2 | | | | | | | | | | |
| Comparative | 1.015 | 4.887 | 2.464 | 3.365 | 0.008 | — | — | — | — | — |
| Example 3 | | | | | | | | | | |
| Comparative | — | — | — | — | — | — | — | — | — | — |
| Example 4 | | | | | | | | | | |

TABLE 3

| | Solid electrolyte | | | | | |
|---|---|---|---|---|---|---|
| | | Ratio | | | | |
| | | [mass %] | | | | |
| | | of first solid | Solid electrolyte | | | |
| | | electrolyte to | layer | | Positive electrode layer | |
| | Composition of first solid | second solid | Thickness | | | Thickness |
| | electrolyte | electrolyte | [μm] | | Constituent material (mass ratio) | [μm] |
| Example A1 | (Li_{6.7}Ga_{0.1})(La_{2.99}Nd_{0.01})Zr₂O₁₂ | 100:0 | 13 | | LiCoO₂/solid electrolyte (60:40) | 10 |
| Example A2 | (Li_{6.7}Ga_{0.1})(La_{2.8}Nd_{0.2})Zr₂O₁₂ | 100:0 | 13 | | LiCoO₂/solid electrolyte (60:40) | 10 |
| Example A3 | (Li_{5.5}Ga_{0.5})(La_{2.95}Nd_{0.05})Zr₂O₁₂ | 100:0 | 13 | | LiCoO₂/solid electrolyte (60:40) | 10 |
| Example A4 | (Li_{4.0}Ga_{1.0})(La_{2.99}Nd_{0.01})Zr₂O₁₂ | 100:0 | 13 | | LiCoO₂/solid electrolyte (60:40) | 10 |
| Example A5 | (Li_{4.0}Ga_{1.0})(La_{2.8}Nd_{0.2})Zr₂O₁₂ | 100:0 | 13 | | LiCoO₂/solid electrolyte (60:40) | 10 |
| Example B1 | (Li_{5.5}Ga_{0.5})(La_{2.95}Nd_{0.05})Zr₂O₁₂ | 100:0 | 13 | | LiCoO₂/solid electrolyte (75:25) | 10 |
| Example B2 | (Li_{5.5}Ga_{0.5})(La_{2.95}Nd_{0.05})Zr₂O₁₂ | 100:0 | 13 | | LiCoO₂/solid electrolyte (50:50) | 10 |
| Example B3 | (Li_{5.5}Ga_{0.5})(La_{2.95}Nd_{0.05})Zr₂O₁₂ | 100:0 | 13 | | LiCoO₂/solid electrolyte (25:75) | 10 |
| Example C1 | (Li_{5.5}Ga_{0.5})(La_{2.95}Nd_{0.05})Zr₂O₁₂ | 100:0 | 13 | | LiCoO₂/solid electrolyte (60:40) | 10 |
| Example C2 | (Li_{5.5}Ga_{0.5})(La_{2.95}Nd_{0.05})Zr₂O₁₂ | 100:0 | 13 | | LiCoO₂/solid electrolyte (60:40) | 10 |
| | | | Internal current | | | |
| | Negative electrode layer | | collecting layer | | | Thickness [μm] |
| | Constituent material | Thickness | Constituent | Thickness | | of entire stacked |
| | (mass ratio) | [μm] | material | [μm] | Number of cells | solid-state battery |
| Example A1 | TiO₂/solid electrolyte (60:40) | 8 | Ni | 1 | 20 | 700 |
| Example A2 | TiO₂/solid electrolyte (60:40) | 8 | Ni | 1 | 20 | 700 |
| Example A3 | TiO₂/solid electrolyte (60:40) | 8 | Ni | 1 | 20 | 700 |
| Example A4 | TiO₂/solid electrolyte (60:40) | 8 | Ni | 1 | 20 | 700 |
| Example A5 | TiO₂/solid electrolyte (60:40) | 8 | Ni | 1 | 20 | 700 |
| Example B1 | TiO₂/solid electrolyte (60:40) | 8 | Ni | 1 | 20 | 700 |
| Example B2 | TiO₂/solid electrolyte (60:40) | 8 | Ni | 1 | 20 | 700 |
| Example B3 | TiO₂/solid electrolyte (60:40) | 8 | Ni | 1 | 20 | 700 |
| Example C1 | TiO₂/solid electrolyte (75:25) | 8 | Ni | 1 | 20 | 700 |
| Example C2 | TiO₂/solid electrolyte (50:50) | 8 | Ni | 1 | 20 | 700 |

TABLE 4

| | Solid electrolyte | | | | | |
|---|---|---|---|---|---|---|
| | | Ratio [mass %] | | | | |
| | | of first solid | Solid electrolyte | | | |
| | | electrolyte to | layer | | Positive electrode layer | |
| | Composition of first solid | second solid | Thickness | | | Thickness |
| | electrolyte | electrolyte | [μm] | | Constituent material (mass ratio) | [μm] |
| Example C3 | (Li_{5.5}Ga_{0.5})(La_{2.95}Nd_{0.05})Zr₂O₁₂ | 100:0 | 13 | | LiCoO₂/solid electrolyte (60:40) | 10 |
| Example D1 | (Li_{5.5}Ga_{0.5})(La_{2.95}Nd_{0.05})Zr₂O₁₂ | 100:0 | 13 | | LiCoO₂/solid electrolyte (60:40) | 10 |
| Example D2 | (Li_{5.5}Ga_{0.5})(La_{2.95}Nd_{0.05})Zr₂O₁₂ | 100:0 | 13 | | LiCoO₂/solid electrolyte (60:40) | 10 |
| Example D3 | (Li_{5.5}Ga_{0.5})(La_{2.95}Nd_{0.05})Zr₂O₁₂ | 100:0 | 13 | | LiCoO₂/solid electrolyte (60:40) | 10 |
| Example E1 | (Li_{5.5}Ga_{0.5})(La_{2.95}Nd_{0.05})Zr₂O₁₂ | 100:0 | 13 | | LiCoO₂/solid electrolyte (60:40) | 10 |
| Example E2 | (Li_{5.5}Ga_{0.5})(La_{2.95}Nd_{0.05})Zr₂O₁₂ | 100:0 | 13 | | LiCoO₂/solid electrolyte (60:40) | 10 |
| Example E3 | (Li_{5.5}Ga_{0.5})(La_{2.95}Nd_{0.05})Zr₂O₁₂ | 100:0 | 13 | | LiCoO₂/solid electrolyte (60:40) | 10 |
| Example F1 | (Li_{5.5}Ga_{0.5})(La_{2.95}Nd_{0.05})Zr₂O₁₂ | 100:0 | 13 | | LiNi_{0.5}Co_{0.2}Mn_{0.3}O₂/solid | 10 |
| | | | | | electrolyte (75:25) | |
| Example F2 | (Li_{5.5}Ga_{0.5})(La_{2.95}Nd_{0.05})Zr₂O₁₂ | 100:0 | 13 | | LiNi_{0.5}Co_{0.2}Mn_{0.3}O₂/solid | 10 |
| | | | | | electrolyte (50:50) | |
| Example F3 | (Li_{5.5}Ga_{0.5})(La_{2.95}Nd_{0.05})Zr₂O₁₂ | 100:0 | 13 | | LiNi_{0.5}Co_{0.2}Mn_{0.3}O₂/solid | 10 |
| | | | | | electrolyte (25:75) | |
| | | | Internal current collecting | | | Thickness [μm] |
| | Negative electrode layer | | layer | | | of entire |
| | | Thickness | Constituent | Thickness | | stacked |
| | Constituent material (mass ratio) | [μm] | material | [μm] | Number of cells | solid-state battery |
| Example C3 | TiO₂/solid electrolyte (25:75) | 8 | Ni | 1 | 20 | 700 |
| Example D1 | Li₄Ti₄O₁₂/solid electrolyte (75:25) | 8 | Ni | 1 | 20 | 700 |
| Example D2 | Li₄Ti₄O₁₂/solid electrolyte (50:50) | 8 | Ni | 1 | 20 | 700 |
| Example D3 | Li₄Ti₄O₁₂/solid electrolyte (25:75) | 8 | Ni | 1 | 20 | 700 |
| Example E1 | Nb₂O₅/solid electrolyte (75:25) | 8 | Ni | 1 | 20 | 700 |
| Example E2 | Nb₂O₅/solid electrolyte (50:50) | 8 | Ni | 1 | 20 | 700 |
| Example E3 | Nb₂O₅/solid electrolyte (25:75) | 8 | Ni | 1 | 20 | 700 |
| Example F1 | TiO₂/solid electrolyte (60:40) | 8 | Ni | 1 | 20 | 700 |
| Example F2 | TiO₂/solid electrolyte (60:40) | 8 | Ni | 1 | 20 | 700 |
| Example F3 | TiO₂/solid electrolyte (60:40) | 8 | Ni | 1 | 20 | 700 |

TABLE 5

| | Solid electrolyte | | | | | |
|---|---|---|---|---|---|---|
| | | Ratio | | | | |
| | | [mass %] | | | | |
| | | of first solid | Solid electrolyte | | | |
| | | electrolyte to | layer | | Positive electrode layer | |
| | Composition of first solid | second solid | Thickness | | | Thickness |
| | electrolyte | electrolyte | [μm] | | Constituent material (mass ratio) | [μm] |
| Example G1 | (Li_{5.5}Ga_{0.5})(La_{2.95}Nd_{0.05})Zr₂O₁₂ | 100:0 | 13 | | Li₃V₂(PO₄)₃/solid electrolyte | 10 |
| | | | | | (75:25) | |
| Example G2 | (Li_{5.5}Ga_{0.5})(La_{2.95}Nd_{0.05})Zr₂O₁₂ | 100:0 | 13 | | Li₃V₂(PO₄)₃/solid electrolyte | 10 |
| | | | | | (50:50) | |
| Example G3 | (Li_{5.5}Ga_{0.5})(La_{2.95}Nd_{0.05})Zr₂O₁₂ | 100:0 | 13 | | Li₃V₂(PO₄)₃/solid electrolyte | 10 |
| | | | | | (25:75) | |
| Example H1 | (Li_{5.5}Ga_{0.5})(La_{2.95}Nd_{0.05})Zr₂O₁₂ | 100:0 | 13 | | Li₃V_{1.6}Al_{0.4}(PO₄)₃/solid | 10 |
| | | | | | electrolyte (75:25) | |
| Example H2 | (Li_{5.5}Ga_{0.5})(La_{2.95}Nd_{0.05})Zr₂O₁₂ | 100:0 | 13 | | Li₃V_{1.6}Al_{0.4}(PO₄)₃/solid | 10 |
| | | | | | electrolyte (50:50) | |
| Example H3 | (Li_{5.5}Ga_{0.5})(La_{2.95}Nd_{0.05})Zr₂O₁₂ | 100:0 | 13 | | Li₃V_{1.6}Al_{0.4}(PO₄)₃/solid | 10 |
| | | | | | electrolyte (25:75) | |
| Example I1 | (Li_{5.5}Ga_{0.5})(La_{2.95}Nd_{0.05})Zr₂O₁₂ | 100:0 | 13 | | LiCoO₂/solid electrolyte (60:40) | 10 |
| Example I2 | (Li_{5.5}Ga_{0.5})(La_{2.95}Nd_{0.05})Zr₂O₁₂ | 100:0 | 13 | | LiCoO₂/solid electrolyte (60:40) | 10 |
| Example J1 | (Li_{5.5}Ga_{0.5})(La_{2.95}Nd_{0.05})Zr₂O₁₂ | 10:90 | 14 | | LiCoO₂/solid electrolyte (60:40) | 10 |
| Example J2 | (Li_{5.5}Ga_{0.5})(La_{2.95}Nd_{0.05})Zr₂O₁₂ | 20:80 | 14 | | LiCoO₂/solid electrolyte (60:40) | 10 |
| | | | Internal current | | | Thickness [μm] |
| | Negative electrode layer | | collecting layer | | | of entire |
| | Constituent material | Thickness | Constituent | Thickness | | stacked solid- |
| | (mass ratio) | [μm] | material | [μm] | Number of cells | state battery |
| Example G1 | TiO₂/solid electrolyte (60:40) | 8 | Ni | 1 | 20 | 700 |
| Example G2 | TiO₂/solid electrolyte (60:40) | 8 | Ni | 1 | 20 | 700 |
| Example G3 | TiO₂/solid electrolyte (60:40) | 8 | Ni | 1 | 20 | 700 |
| Example H1 | TiO₂/solid electrolyte (60:40) | 8 | Ni | 1 | 20 | 700 |
| Example H2 | TiO₂/solid electrolyte (60:40) | 8 | Ni | 1 | 20 | 700 |
| Example H3 | TiO₂/solid electrolyte (60:40) | 8 | Ni | 1 | 20 | 700 |
| Example I1 | TiO₂/solid electrolyte (50:50) | 8 | Ni | 1 | 20 | 700 |
| Example I2 | TiO₂/solid electrolyte (50:50) | 8 | Ni | 1 | 20 | 700 |
| Example J1 | TiO₂/solid electrolyte (50:50) | 8 | Ni | 1 | 20 | 720 |
| Example J2 | TiO₂/solid electrolyte (60:40) | 8 | Ni | 1 | 20 | 720 |

TABLE 6

| | Solid electrolyte | | | | | |
|---|---|---|---|---|---|---|
| | | Ratio | | | | |
| | | [mass %] | | | | |
| | | of first solid | Solid electrolyte | | | |
| | | electrolyte to | layer | | Positive electrode layer | |
| | Composition of first solid | second solid | Thickness | | Constituent material | Thickness |
| | electrolyte | electrolyte | [μm] | | (mass ratio) | [μm] |
| Example J3 | (Li_{5.5}Ga_{0.5})(La_{2.95}Nd_{0.05})Zr₂O₁₂ | 30:70 | 13 | | LiCoO₂/solid electrolyte (60:40) | 10 |
| Example J4 | (Li_{5.5}Ga_{0.5})(La_{2.95}Nd_{0.05})Zr₂O₁₂ | 40:60 | 13 | | LiCoO₂/solid electrolyte (60:40) | 10 |
| Example J5 | (Li_{5.5}Ga_{0.5})(La_{2.95}Nd_{0.05})Zr₂O₁₂ | 50:50 | 12 | | LiCoO₂/solid electrolyte (60:40) | 10 |
| Example J6 | (Li_{5.5}Ga_{0.5})(La_{2.95}Nd_{0.05})Zr₂O₁₂ | 60:40 | 12 | | LiCoO₂/solid electrolyte (60:40) | 10 |
| Example J7 | (Li_{5.5}Ga_{0.5})(La_{2.95}Nd_{0.05})Zr₂O₁₂ | 70:30 | 11 | | LiCoO₂/solid electrolyte (60:40) | 10 |
| Example J8 | (Li_{5.5}Ga_{0.5})(La_{2.95}Nd_{0.05})Zr₂O₁₂ | 80:20 | 11 | | LiCoO₂/solid electrolyte (60:40) | 10 |
| Example J9 | (Li_{5.5}Ga_{0.5})(La_{2.95}Nd_{0.05})Zr₂O₁₂ | 90:10 | 13 | | LiCoO₂/solid electrolyte (60:40) | 10 |
| | | | Internal current | | | Thickness [μm] |
| | Negative electrode layer | | collecting layer | | | of entire |
| | Constituent material | Thickness | Constituent | Thickness | | stacked solid- |
| | (mass ratio) | [μm] | material | [μm] | Number of cells | state battery |
| Example J3 | TiO₂/solid electrolyte (60:40) | 8 | Ni | 1 | 20 | 700 |
| Example J4 | TiO₂/solid electrolyte (60:40) | 8 | Ni | 1 | 20 | 700 |
| Example J5 | TiO₂/solid electrolyte (60:40) | 8 | Ni | 1 | 20 | 680 |
| Example J6 | TiO₂/solid electrolyte (60:40) | 8 | Ni | 1 | 20 | 680 |
| Example J7 | TiO₂/solid electrolyte (60:40) | 8 | Ni | 1 | 20 | 660 |
| Example J8 | TiO₂/solid electrolyte (60:40) | 8 | Ni | 1 | 20 | 660 |
| Example J9 | TiO₂/solid electrolyte (60:40) | 8 | Ni | 1 | 20 | 700 |

TABLE 7

| | Solid electrolyte | | | | | |
|---|---|---|---|---|---|---|
| | | Ratio | | | | |
| | | [mass %] | | | | |
| | | of first solid | Solid electrolyte | | | |
| | | electrolyte to | layer | | Positive electrode layer | |
| | Composition of first solid | second solid | Thickness | | Constituent material | Thickness |
| | electrolyte | electrolyte | [μm] | | (mass ratio) | [μm] |
| Comparative | Li_{6.985}Ga_{0.005}La_{2.95}Nd_{0.005}Zr₂O₁₂ | 100:0 | 13 | | LiCoO₂/solid electrolyte | 10 |
| Example 1 | | | | | (60:40) | |
| Comparative | Li_{5.5}Ga_{0.5}La_{2.95}Nd_{0.005}Zr₂O₁₂ | 100:0 | 13 | | LiCoO₂/solid electrolyte | 10 |
| Example 2 | | | | | (60:40) | |
| Comparative | Li_{5.5}Ga_{0.5}La_{2.8}Nd_{0.2}Zr₂O₁₂ | 100:0 | 13 | | LiCoO₂/solid electrolyte | 10 |
| Example 3 | | | | | (60:40) | |
| Comparative | — | 0:100 | 13 | | LiCoO₂/solid electrolyte | 10 |
| Example 4 | | | | | (60:40) | |
| | | | Internal current | | | Thickness [μm] |
| | Negative electrode layer | | collecting layer | | | of entire |
| | Constituent material | Thickness | Constituent | Thickness | | stacked solid- |
| | (mass ratio) | [μm] | material | [μm] | Number of cells | state battery |
| Comparative | TiO₂/solid electrolyte (60:40) | 8 | Ni | 1 | 20 | 700 |
| Example 1 | | | | | | |
| Comparative | TiO₂/solid electrolyte (60:40) | 8 | Ni | 1 | 20 | 700 |
| Example 2 | | | | | | |
| Comparative | TiO₂/solid electrolyte (60:40) | 8 | Ni | 1 | 20 | 700 |
| Example 3 | | | | | | |
| Comparative | TiO₂/solid electrolyte (60:40) | 8 | Ni | 1 | 20 | 700 |
| Example 4 | | | | | | |

### 8 Evaluation

### 8-1 Evaluation of Ion Conductivity of Solid Electrolyte Constituting Solid Electrolyte Layer

Each of the mixed powders of the first solid electrolyte and the second solid electrolyte obtained in the manufacturing process of the stacked solid-state batteries of the respective Examples and Comparative Examples was weighed to 200 mg, and filled in a die punch with an exhaust port having an inner diameter of 10.00 mm (manufactured by specac Cop., Ltd.), and uniaxial pressing was performed at a pressure of 600 MPa. The obtained solid electrolyte pellet was fired at 900° C. for 8 hours in an air atmosphere to prepare a sintered body.

An electrode layer of gold was formed on both surfaces of each sintered body obtained as described above by sputtering, and ion conductivity σ was measured for these layers.

The ion conductivity σ was determined according to the following formula (3) by forming a gold sputtered electrode layer on the both surfaces of the sintered body, performing AC impedance analysis in a range of a sweep frequency of 10 mHz to 1 MHz at an AC amplitude of 10 mV.

σ=L/RA (3)

In the formula (3), L indicates a thickness, R indicates an impedance, and A indicates an electrode area.

In Comparative Example 4 in which the first solid electrolyte layer was not used in the manufacturing of the stacked solid-state battery, the sintered body was manufactured in the same manner as described above except that the powdery second solid electrolyte was used instead of the mixed powder, and the ion conductivity σ was measured.

### 8-2 Evaluation of Charge/Discharge Operation Characteristics of Stacked Solid-State Battery

Each of the stacked solid-state batteries obtained in the respective Examples and Comparative Examples was evaluated by being coupled to a charge/discharge evaluation device HJ1001SD8 (manufactured by Hokuto Denko Corporation), and performing a charge/discharge cycle test at 25° C. in a range of a lower limit cutoff voltage of 1.5 V and an upper limit cutoff voltage of 3.7 V. The charge/discharge cycle test was carried out under conditions of 0.2 C of charge and 0.1 C to 2 C of discharge, and the charge/discharge operation characteristics were confirmed.

The results are summarized in Tables 8 and 9.

TABLE 8

| | |
|---|---|
| Ion conductivity | Battery capacity (mAh/g) |

| | [×10⁻⁴ S/cm] | 0.2 C | 1 C | 2 C |
|---|---|---|---|---|
| Example A1 | 1.3 | 1.86 | 1.12 | 0.76 |
| Example A2 | 4.9 | 1.90 | 1.19 | 0.81 |
| Example A3 | 7.9 | 2.11 | 1.25 | 1.00 |
| Example A4 | 5.4 | 1.92 | 1.22 | 0.92 |
| Example A5 | 2.2 | 1.87 | 1.17 | 0.79 |
| Example B1 | 7.9 | 2.12 | 1.29 | 1.32 |
| Example B2 | 7.9 | 1.67 | 1.07 | 0.86 |
| Example B3 | 7.9 | 0.82 | 0.63 | 0.54 |
| Example C1 | 7.9 | 1.95 | 1.87 | 0.77 |
| Example C2 | 7.9 | 1.66 | 1.10 | 0.80 |
| Example C3 | 7.9 | 0.74 | 0.53 | 0.44 |
| Example D1 | 7.9 | 2.01 | 1.82 | 1.52 |
| Example D2 | 7.9 | 1.59 | 1.33 | 1.04 |
| Example D3 | 7.9 | 0.70 | 0.52 | 0.46 |
| Example E1 | 7.9 | 1.99 | 1.70 | 1.21 |
| Example E2 | 7.9 | 1.49 | 1.12 | 0.89 |
| Example E3 | 7.9 | 0.67 | 0.49 | 0.38 |
| Example F1 | 7.9 | 2.71 | 2.24 | 1.92 |
| Example F2 | 7.9 | 1.84 | 1.59 | 1.37 |
| Example F3 | 7.9 | 0.90 | 0.72 | 0.61 |
| Example G1 | 7.9 | 1.71 | 1.31 | 1.07 |

TABLE 9

| | |
|---|---|
| Ion conductivity | Battery capacity (mAh/g) |

| | [×10⁻⁴ S/cm] | 0.2 C | 1 C | 2 C |
|---|---|---|---|---|
| Example G2 | 7.9 | 1.45 | 1.12 | 0.93 |
| Example G3 | 7.9 | 0.65 | 0.42 | 0.28 |
| Example H1 | 7.9 | 1.48 | 1.21 | 1.01 |
| Example H2 | 7.9 | 1.26 | 0.99 | 0.82 |
| Example H3 | 7.9 | 0.56 | 0.38 | 0.29 |
| Example I1 | 8.1 | 2.01 | 1.86 | 1.65 |
| Example I2 | 8.2 | 2.00 | 1.77 | 1.52 |
| Example J1 | 5.2 | 1.99 | 1.84 | 1.56 |
| Example J2 | 7.4 | 2.01 | 1.83 | 1.65 |
| Example J3 | 7.9 | 1.96 | 1.77 | 1.58 |
| Example J4 | 5.4 | 1.97 | 1.76 | 1.53 |
| Example J5 | 7.1 | 2.02 | 1.87 | 1.59 |
| Example J6 | 5.8 | 1.98 | 1.81 | 1.61 |
| Example J7 | 6.0 | 1.99 | 1.77 | 1.55 |
| Example J8 | 7.8 | 1.97 | 1.75 | 1.52 |
| Example J9 | 6.9 | 1.95 | 1.70 | 1.49 |
| Comparative | 0.34 | 1.18 | 0.89 | 0.67 |
| Example 1 | | | | |
| Comparative | 0.78 | 1.23 | 0.99 | 0.81 |
| Example 2 | | | | |
| Comparative | 0.67 | 1.30 | 1.11 | 0.86 |
| Example 3 | | | | |
| Comparative | 2.4 | 1.21 | 0.91 | 0.75 |
| Example 4 | | | | |

As is clear from Tables 8 and 9, in the present disclosure, excellent results were all obtained, whereas in Comparative Examples, satisfactory results were not obtained.

What is claimed is:

1. A stacked solid-state battery having a configuration in which a plurality of cells, each including a positive electrode layer, a negative electrode layer, and a solid electrolyte layer provided between the positive electrode layer and the negative electrode layer, are stacked such that the positive electrode layers or the negative electrode layers of adjacent cells are disposed to face each other, the stacked solid-state battery comprising:
a first solid electrolyte represented by the following composition formula (1):
(Li₇₋₃ₓGaₓ)(La_{3-y}Nd_{y})Zr₂O₁₂ (1)
(in the formula (1), 0.1≤x≤1.0 and 0.01≤y≤0.20).

2. The stacked solid-state battery according to claim 1, wherein
the first solid electrolyte is contained in the solid electrolyte layer.

3. The stacked solid-state battery according to claim 2, wherein
the solid electrolyte layer contains a second solid electrolyte having a NASICON-type crystal structure in addition to the first solid electrolyte.

4. The stacked solid-state battery according to claim 3, wherein
the second solid electrolyte is a lithium-containing phosphate compound.

5. The stacked solid-state battery according to claim 3, wherein
0.10≤X1/X2≤9.0 where a content of the first solid electrolyte is X1 [mass %] and a content of the second solid electrolyte is X2 [mass %] in the solid electrolyte layer.

6. The stacked solid-state battery according to claim 1, further comprising:
an internal current collecting layer between the adjacent cells.
